(19) United States
(12) Patent Application Publication
(10) Pub. No.: US 2009/0139675 A1
(43) Pub. Date: Jun. 4, 2009

(54) Fine-Particled Polymer Dispersions Containing Starch

(75) Inventors: Hildegard Stein, Mannheim (DE); Roland Ettl, Ketsch (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/993,919

(22) PCT Filed: Jun. 23, 2006
(86) PCT No.: PCT/EP2006/063502

§ 371 Date: Dec. 26, 2007

(30) Foreign Application Priority Data
Jun. 29, 2005 (DE) 10 2005 030 787.6

(51) Int. Cl. D21H 21/16; C08L 67/00; D21H 17/46

(52) U.S. Cl. 162/164.6; 524/845; 162/164.7

(57) ABSTRACT

Finely divided, starch-containing polymer dispersions obtainable by emulsion copolymerization, with redox initiators, of ethylenically unsaturated monomers from the group consisting of
(a) from 45 to 55% by weight of at least one optionally substituted styrene, methyl methacrylate, acrylonitrile and/or methacrylonitrile,
(b) from 15 to 29% by weight of at least one C₁-C₁₂-alkyl acrylate and/or one C₂-C₁₂-alkyl methacrylate and
(c) from 0 to 10% by weight of at least one other ethylenically unsaturated copolymerizable monomer
in an aqueous medium in the presence of
(d) from 15 to 35% by weight of a degraded cationized starch which has a molar mass M_{w} of from 1000 to 65 000, the sum (a)+(b)+(c)+(d) being 100% and being based on the total solids content, processes for the preparation of such polymer dispersions by emulsion polymerization of the monomers (a), (b) and (c) in an aqueous medium with redox initiators in the presence of (d) cationic starch, and use of the starch-containing polymer dispersions as size for paper, board and cardboard.

The invention relates to finely divided, starch-containing polymer dispersions which are obtainable by emulsion polymerization of ethylenically unsaturated monomers in the presence of at least one redox initiator and starch, processes for the preparation of the dispersions and their use as sizes for paper.

EP-B-0 276 770 and EP-B-0 257 412 disclose sizes based on finely divided, aqueous dispersions which are obtainable by copolymerization of ethylenically unsaturated monomers, such as acrylonitrile and (meth)acrylates and, if appropriate, up to 10% by weight of other monomers, such as styrene, by an emulsion polymerization method in the presence of initiators comprising peroxide groups, in particular of redox initiators, and degraded starch.

EP-A-0 307 812 describes, as sizes, inter alia also finely divided, aqueous, cationic polymer dispersions which are obtainable by emulsion copolymerization of
(i) acrylonitrile, methacrylonitrile, methyl methacrylate and/or styrene,
(ii) at least one acrylate or methacrylate of in each case monohydric, saturated C₃-C₈-alcohols, vinyl acetate, vinyl propionate and/or 1,3-butadiene and, if appropriate,
(iii) other ethylenically unsaturated monomers in an aqueous solution of a degraded cationic starch in the presence of a redox initiator.

EP-A-0 536 597 discloses aqueous polymer dispersions which are obtainable by free radical emulsion copolymerization of unsaturated monomers in the presence of a starch degradation product. The starch degradation product forms as a result of hydrolysis in the aqueous phase and, at room temperature, has complete solubility in water at a weight average molecular weight M_{w} of from 2500 to 25 000. Preferably used monomer mixtures are mixtures of styrene and (meth)acrylates of monohydric, saturated C₁-C₁₂-alcohols in combination with up to 10% by weight of acrylic acid and/or methacrylic acid. The dispersions are used as binder, adhesive or size for fibers or for the production of coatings.

EP-B-1 056 783 likewise discloses aqueous, finely divided polymer dispersions which are used for the surface sizing of paper, board and cardboard. The dispersions are obtainable by free radical emulsion polymerization of ethylenically unsaturated monomers in the presence of degraded starch having a number average molecular weight Mₙ of from 500 to 10 000. The monomer mixtures consist of (i) at least one optionally substituted styrene, (ii) at least one C₁-C₄-alkyl (meth)acrylate and (iii) if appropriate up to 10% by weight of other ethylenically unsaturated monomers. The polymerization is effected in the presence of a graft-linking, water-soluble redox system.

WO-A-00/23479 likewise discloses sizes which are obtainable by free radical emulsion copolymerization of a monomer mixture (A) comprising, for example, (i) at least one optionally substituted styrene, (ii) if appropriate at least one C₄-C₁₂-alkyl (meth)acrylate and (iii) at least one monomer from the group consisting of methyl acrylate, ethyl acrylate and propyl acrylate in the presence of (B) starch having an average molecular weight of 1000 or more, the weight ratio of (A):(B) being from 0.6:1 to 1.7:1; the size is free of emulsifiers or surface-active agents having a molecular weight of less than 1000 and comprises virtually no monomers which have acid groups and are incorporated in the form of polymerized units. Cationic starch, in particular oxidized cationic waxy maize starch, is preferred as component (B) of the size, and the component (A) preferably consists of a mixture of styrene, n-butyl acrylate and methyl acrylate.

EP-B-1 165 642 discloses a further polymer dispersion and a process for its preparation, a monomer mixture which comprises at least one vinyl monomer being polymerized in an aqueous solution of a starch which has a degree of substitution (DS), based on the cationic or anionic substituents, of from 0.01 to 1 and, in cationized and/or anionized form, has a limiting viscosity of >1.0 dl/g. The starch used in the polymerization is either not degraded or only slightly oxidized but on no account enzymatically degraded. The resulting polymer has a film formation temperature of −50 to +200° C. It is composed, for example, of acrylates and styrene and, if appropriate, acrylonitrile. The polymer dispersions thus preparable are used as sizes for paper.

According to the process disclosed in WO-A-02/14393, sizes and coating materials for paper are prepared by free radical emulsion polymerization of a monomer mixture comprising (i) at least one (meth)acrylate of monohydric, saturated C₃-C₈-alcohols and (ii) one or more further ethylenically unsaturated monomers in the presence of starch and/or of a starch derivative, monomers and initiator being fed continuously to an aqueous starch solution, and the initiator being metered in two portions under specially defined conditions.

Also known are starch-based polymers which can be prepared by polymerization of (i) from 35 to 65% by weight of an ethylenically unsaturated monomer which is free of carboxyl groups, (ii) from 35 to 65% by weight of an ethylenically unsaturated mono- or dicarboxylic acid or the salts thereof and (iii) from 0 to 15% by weight of another ethylenically unsaturated monomer in an aqueous medium in the presence of starch, cf. WO-A-2004/078807. The starch used may be natural starch, dextrin and starch derivatives. The polymers formed are water-soluble. They are used as sizes for paper, board and cardboard.

It is the object of the invention to provide further starch-containing polymer dispersions which have improved performance characteristics compared with the known, comparable polymer dispersions, for example an improved sizing effect and printability, in particular inkjet printability, and toner adhesion.

The object is achieved, according to the invention, by finely divided, starch-containing polymer dispersions which are obtainable by free radical emulsion copolymerization of ethylenically unsaturated monomers in the presence of at least one redox initiator and starch, if
(a) from 45 to 55% by weight of at least one optionally substituted styrene, methyl methacrylate, acrylonitrile and/or methacrylonitrile,
(b) from 15 to 29% by weight of at least one C₁-C₁₂-alkyl acrylate and/or one C₂-C₁₂-alkyl methacrylate and
(c) from 0 to 10% by weight of at least one other ethylenically unsaturated copolymerizable monomer
   are used as ethylenically unsaturated monomers and
(d) from 15 to 35% by weight of a degradable cationized starch which has a molar mass M_{w} of from 1000 to 65 000
   are used as starch,
   the sum (a)+(b)+(c)+(d) being 100% and being based on the total solids content.

Preferred polymer dispersions are those which are prepared using
(a) from 47 to 51 % by weight of at least one optionally substituted styrene, methyl methacrylate, acrylonitrile and/or methacrylonitrile,
(b) from 19 to 25% by weight of at least one C₁-C₁₂-alkyl acrylate and/or one C₂-C₁₂-alkyl methacrylate and
(c) from 0 to 10% by weight of at least one other ethylenically unsaturated copolymerizable monomer,
   as unsaturated monomers and
(d) from 24 to 30% by weight of a degraded cationized starch which has a molar mass M_{w} of from 2500 to 35 000,
   as starch,
   the sum (a)+(b)+(c)+(d) being 100% and being based on the total solids content.

Particularly preferred dispersions are those which are prepared using
(a) from 47 to 51% by weight of at least one monomer from the group consisting of styrene, methyl methacrylate, acrylonitrile and/or methacrylonitrile,
(b) from 19 to 25% by weight of at least one C₁-C₁₂-alkyl acrylate and/or one C₂-C₁₂-alkyl methacrylate and
(c) from 0 to 10% by weight of at least one monomer from the group consisting of stearyl acrylate, stearyl methacrylate, palmityl acrylate, behenyl acrylate, behenyl methacrylate, vinyl acetate, vinyl propionate, hydroxyethyl acrylate, hydroxyethyl methacrylate, N-vinylformamide, acrylamide, methacrylamide, N-vinylpyrrolidone, N-vinylcaprolactam, N-vinylimidazole, acrylic acid, methacrylic acid, acrylamidomethylpropanesulfonic acid, vinylsulfonic acid, styrenesulfonic acid and salts of the monomers comprising acid groups
   as ethylenically unsaturated monomers and
(d) from 24 to 30% by weight of a degraded cationized starch which has the molar mass M_{w} of from 2500 to 35 000
   as starch,
   the sum (a)+(b)+(c)+(d) being 100% and being based on the total solids content.

From 19 to 25% by weight of n-butyl acrylate, sec-butyl acrylate, isobutyl acrylate, tert-butyl acrylate and/or 2-ethylhexyl acrylate are particularly suitable as component (b) of the particularly preferred starch-containing polymer dispersions.

The invention also relates to a process for the preparation of the finely divided, starch-containing polymer dispersions,
(a) from 45 to 55% by weight of at least one optionally substituted styrene, methyl methacrylate, acrylonitrile and/or methacrylonitrile,
(b) from 15 to 29% by weight of at least one C₁-C₁₂-alkyl acrylate and/or one C₂-C₁₂-alkyl methacrylate,
(c) from 0 to 10% by weight of at least one other ethylenically unsaturated copolymerizable monomer
   and
(d) from 15 to 35% by weight of a degraded cationized starch which has a molar mass M_{w} of from 1000 to 65 000, the sum (a)+(b)+(c)+(d) being 100%, being polymerized in the presence of a redox initiator in an aqueous medium.

Ethylenically unsaturated monomers of group (a) are, for example, styrene, substituted styrenes, such as α-methylstyrene, methyl methacrylate, acrylonitrile or methacrylonitrile. Preferably used monomers of this group are styrene and methyl methacrylate. Optionally substituted styrenes are also to be understood as meaning styrenes halogenated from the ring, such as chlorostyrene, or C₁- to C₄-substituted styrenes, such as vinyltoluene.

Suitable monomers of group (b) are, for example, all esters of acrylic acid and of methacrylic acid which are derived from monohydric C₂- to C₁₂-alcohols, such as ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate, sec-butyl acrylate, sec-butyl methacrylate, n-pentyl acrylate, n-pentyl methacrylate, neopentyl acrylate, neopentyl methacrylate, cyclohexyl acrylate, cyclohexyl methacrylate, 2-hexyl acrylate, 2-hexyl methacrylate, 2-ethylhexyl acrylate, 2-ethylhexyl methacrylate, n-octyl acrylate, n-octyl methacrylate, isooctyl acrylate, isooctyl methacrylate, decyl acrylate and decyl methacrylate, dodecyl acrylate and dodecyl methacrylate. Another suitable acrylate is methyl acrylate. Preferably used monomers of this group are n-butyl acrylate, sec-butyl acrylate, isobutyl acrylate and tert-butyl acrylate.

Examples of monomers of group (c) are stearyl acrylate, stearyl methacrylate, palmityl acrylate, behenyl acrylate, behenyl methacrylate, vinyl acetate, vinyl propionate, hydroxyethyl acrylate, hydroxyethyl methacrylate, N-vinylformamide, acrylamide, methacrylamide, N-vinylpyrrolidone, N-vinylimidazole, N-vinylcaprolactam, acrylic acid, methacrylic acid, acrylamidomethylpropanesulfonic acid, vinylsulfonic acid, styrenesulfonic acid and salts of the monomers comprising acid groups. The acidic monomers may be used in partly or completely neutralized form. Neutralizing agents used are, for example, sodium hydroxide solution, potassium hydroxide solution, sodium carbonate, sodium bicarbonate, calcium hydroxide and ammonia.

Further examples of monomers (c) are dialkylaminoalkyl (meth)acrylates and dialkylaminoalkyl(meth)acrylamides, such as dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, dimethylaminoethylacrylamide, dimethylaminoethylmethacrylamide, dimethylaminopropylacrylamide and dimethylaminopropylmethacrylamide. The basic monomers can be used in the form of the free bases, as salts with organic acids or mineral acids or in quaternized form in the polymerization. The monomers of group (d) are present in an amount of, for example, from 0 to 10% by weight in the reaction mixture comprising the components (a), (b), (c) and (d). If they are used for modifying the polymers, the preferably used amounts are from 0.5 to 8% by weight, based on the reaction mixture comprising the components (a), (b), (c) and (d).

The polymerization of the monomers is effected in the presence of a degraded cationized starch which has a molar mass M_{w} of from 1000 to 65 000. If the molecular weight M_{w} of the cationized starch used is not already in the range from 1000 to 65 000, the molecular weight of said starch can be degraded, for example enzymatically and/or oxidatively, if appropriate before the beginning of polymerization or in a separate step. The molar mass M_{w} of the degraded cationized starch is preferably in the range from 2500 to 35 000. The average molecular weight M_{w} of the degraded starches can readily be determined by methods known to the person skilled in the art, for example by means of gel permeation chromatography using a multi-angle scattered light detector.

Cationized starches are known. They are prepared, for example, by reacting natural starch with at least one quaternizing agent, such as 2,3-epoxypropyltrimethylammonium chloride. The cationized starches comprise quaternary ammonium groups. The proportion of the cationic groups in the cationized starch is stated with the aid of the degree of substitution (DS). It is, for example, from 0.005 to 1.0, preferably from 0.01 to 0.5.

All cationic starches may be used. Customary cationic starches are prepared, for example, by reacting natural starches, such as potato, wheat, corn, rice or tapioca starch, sorghum or waxy starches, which have a content of amylopectin of >80%, preferably >95%, such as waxy maize starch or waxy potato starch, with at least one quaternizing agent. Starch types having a high content of amylopectin of 80% or higher are preferably used. The cationized starches can be further modified, for example hydrophobically modified, by etherification, esterification or crosslinking. The degradation of the cationized starches can be effected before or during the polymerization of the monomers. The starch degradation is preferably carried out before the polymerization. It can be carried out oxidatively, thermally, acidolytically or enzymatically. The starch degradation is preferably effected enzymatically and/or oxidatively directly before the beginning of the emulsion polymerization in the polymerization apparatus or in a separate step. It is possible to use a single degraded cationized starch or mixtures of two or more degraded cationic starches in the polymerization.

In order to initiate the polymerization, according to the invention a redox initiator is used. Redox initiators are preferably graft-linking, water-soluble redox systems, for example comprising hydrogen peroxide and a heavy metal salt or comprising hydrogen peroxide and sulfur dioxide or comprising hydrogen peroxide and sodium metabisulfite. Further suitable redox systems are combinations of tert-butyl hydroperoxide and/or sulfur dioxide, sodium or potassium persulfate/sodium bisulfite, ammonium persulfate/sodium bisulfite or ammonium persulfate/iron(II) sulfate. Preferably, hydrogen peroxide is used in combination with a heavy metal salt, such as iron(II) sulfate. Frequently, the redox system additionally comprises a further reducing agent, such as ascorbic acid, sodium formaldehyde sulfoxylate, sodium disulfite and/or sodium dithionite. Since the polymerization of the monomers is effected in the presence of starch and since starch likewise acts as a reducing agent, in general the concomitant use of further reducing agents is dispensed with. The redox initiators are used, for example, in an amount of from 0.05 to 5% by weight, preferably from 0.1 to 4% by weight, based on the monomers.

The emulsion polymerization of the monomers (a) to (c) is effected in an aqueous medium in the presence of a cationized starch (d). The polymerization can be carried out both by the feed process and by a batch process. Preferably, an aqueous solution of a degraded cationic starch and of a heavy metal salt is initially taken and the monomers are added either separately or as a mixture and, separately therefrom, the oxidizing part of the redox initiator, preferably hydrogen peroxide, is added, continuously or discontinuously or batchwise. A step or gradient procedure which is disclosed in WO-A-02/14393 can also be used for the preparation of the starch-containing polymer dispersions. There, the addition can be effected uniformly or nonuniformly over the metering period, i.e. with changing metering rate.

The polymerization is usually carried out in the absence of oxygen, preferably in an inert gas atmosphere, for example under nitrogen. During the polymerization, thorough mixing of the components should be ensured. Thus, the reaction mixture is preferably stirred during the entire duration of the polymerization and of any subsequent postpolymerization.

The polymerization is usually carried out at temperatures of from 30 to 110° C., preferably from 50 to 100° C. The use of a pressure reactor or carrying out a continuous polymerization in a stirred kettle cascade or flow tube is also possible.

In order to increase the dispersing effect, conventional ionic, nonionic or amphoteric emulsifiers can be added to the polymerization batch. Conventional emulsifiers are used only if appropriate. The amounts used are from 0 to 3% by weight and are preferably in the range from 0.02 to 2% by weight, based on the sum of the monomers (a) to (c) used. However, the emulsion polymerization is particularly preferably carried out in the absence of an emulsifier. Conventional emulsifiers are described in detail in the literature, cf. for example M. Ash, I. Ash, Handbook of Industrial Surfactants, Third Edition, Synapse Information Resources Inc. Examples of conventional emulsifiers are the reaction products of long-chain monohydric alcohols (C₁₀- to C₂₂-alkanols) with from 4 to 50 mol of ethylene oxide and/or propylene oxide per mole of alcohol or ethoxylated phenols or alkoxylated alcohols esterified with sulfuric acid which are generally used in a form neutralized with alkali. Further conventional emulsifiers are, for example, sodium alkanesulfonates, sodium alkylsulfates, sodium dodecylbenzenesulfonate, sulfosuccinic esters, quaternary alkylammonium salts, alkylbenzylammonium salts, such as dimethyl-C₁₂- to C₁₈-alkylbenzylammonium chlorides, primary, secondary and tertiary fatty amine salts, quaternary amidoamine compounds, alkylpyridiniumsalts, alkylimidazolinium salts and alkyloxazolinium salts.

During the emulsion polymerization, either the monomers can be metered directly into the initially taken mixture or they can be added in the form of an aqueous emulsion or miniemulsion to the polymerization batch. For this purpose, the monomers are emulsified in water using the abovementioned conventional emulsifiers.

The polymerization can, if appropriate, also be carried out in the presence of conventional regulators. In principle, all known regulators which reduce the molecular weight of the polymers forming can be used, but preferably used regulators are organic compounds which comprise sulfur in bound form, for example mercaptans, di- and polysulfides, esters and sulfides of thio- and dithiocarboxylic acids and enol sulfides. Halogen compounds, aldehydes, ketones, formic acid, enol ethers, enamines, hydroxylamine, halogenated hydrocarbons, alcohols, ethylbenzene and xylene are also suitable as regulators.

Examples of regulators based on organic compounds which comprise sulfur in bound form are mercaptoethanol, mercaptopropanol, mercaptobutanol, thioglycolic acid, thioacetic acid, thiopropionic acid, thioethanolamine, sodium dimethyidithiocarbamate, cysteine, ethyl thioglycolate, trimethylolpropane trithioglycolate, pentaerythrityl tetra(mercaptopropionate), pentaerythrityl tetrathioglycolate, trimethylolpropane tri(mercaptoacetate), butyl methylenebisthioglycolate, thioglycerol, glyceryl monothioglycolate, n-octadecyl mercaptan, n-dodecyl mercaptan, tert-dodecyl mercaptan, butyl mercaptan, thiophenol, mercaptotrimethoxysilane and acetylcysteine.

Other suitable regulators are halogen compounds, such as trichloromethane, tetrachloromethane and bromotrichloromethane, aldehydes, such as acetaldehyde, propionaldehyde, crotonaldehyde and butyraldehyde, alcohols, such as n-propanol and isopropanol and buten-3-ol and allyl alcohol. Further suitable regulators are vitamin A acetate, vitamin A palmitate, geranial, neral, geraniol, geranyl acetate, limonene, linalyl acetate, terpinolene, γ-terpinene, α-terpinene, R(−)-α-phellandrene, terpineol, resorcinol, hydroquinone, pyrocatechol, phloroglucine and diphenylethylene. Further examples of regulators based on terpinolene and unsaturated alicyclic hydrocarbons are to be found, for example, in Winnacker-Küchler, Chemische Technologie, Volume 6, pages 374 to 381, Carl Hanser Verlag, Munich, Vienna, 1982.

The amount of regulator is, for example, from 0 to 5, preferably from 0.1 to 2, % by weight, based on the monomers (a)-(c).

The polymerization is carried out at a pH of from 2 to 9, preferably in the weakly acidic range at a pH of from 3 to 5.5. The pH can be adjusted to the desired value before or during the polymerization using conventional acids, such as hydrochloric acid, sulfuric acid or acetic acid, or using bases, such as sodium hydroxide solution, potassium hydroxide solution, ammonia, ammonium carbonate, etc. The dispersion is preferably adjusted to a pH of from 5 to 7 with sodium hydroxide solution, potassium hydroxide solution or ammonia after the end of the polymerization.

In order to remove the remaining monomers from the starch-containing polymer dispersion as substantially as possible, a postpolymerization is expediently carried out. For this purpose, an initiator from the group consisting of hydrogen peroxide, peroxides, hydroperoxides and/or azo initiators is added to the polymer dispersion after the end of the main polymerization. The combination of the initiators with suitable reducing agents, such as, for example, ascorbic acid or sodium bisulfite, is also possible. Oil-soluble initiators which are sparingly soluble in water are preferably used, for example conventional organic peroxides, such as dibenzoyl peroxide, di-tert-butyl peroxide, tert-butyl hydroperoxide, cumyl hydroperoxide or biscyclohexyl peroxydicarbonate. For the postpolymerization, the reaction mixture is heated, for example, to a temperature which corresponds to the temperature at which the main polymerization was carried out or which is up to 20° C., preferably up to 10° C., higher. The main polymerization is complete when the polymerization initiator has been consumed or the monomer conversion is, for example, at least 98%, preferably at least 99.5%. tert-Butyl hydroperoxide is preferably used for the postpolymerization. The postpolymerization is carried out, for example, in a temperature range from 35 to 100° C., in general from 45 to 95° C.

After the end of the polymerization, a complexing agent for heavy metal ions can be added to the polymer dispersion in an amount such that all heavy metal ions are bound in complexed form. The starch-containing polymer dispersions comprise dispersed particles having a mean particle size of from 20 to 500 nm, preferably from 50 to 250 nm. The mean particle size can be determined by means of methods known to the person skilled in the art, such as, for example, laser correlation spectroscopy, ultracentrifuging or HDF (hydrodynamic fractionation). A further measure of the particle size of the dispersed polymer particles is the LT value. In order to determine the LT value (light transmittance), the polymer dispersion to be investigated in each case is measured in 0.1% strength by weight aqueous dilution in a cell of edge length 2.5 cm using light of 600 nm wavelength and compared with the corresponding transmittance of water under the same measuring conditions. The transmittance of water is specified as 100%. The more finely divided the dispersion, the higher is the LT value which is measured by the method described above. From the measured values, the mean particle size can be calculated, cf. B. Verner, M. Bárta, B. Sedlácek, Tables of Scattering Functions for Spherical Particles, Prague, 1976, Edice Marco, Rada D-DATA, SVAZEK D-1. The solid content of the starch-containing polymer dispersion is, for example, from 5 to 50% by weight and is preferably in the range from 15 to 40% by weight.

The starch-containing polymer dispersions described above are used as sizes for paper, board and cardboard. They can be used both as surface size and as engine size in the respective conventional amounts. The use as surface size is preferred. The dispersions according to the invention can be processed by all methods suitable for surface sizing. For the application, the dispersion is usually added to the size press liquor in an amount of from 0.05 to 5% by weight, based on solid substance, and depends on the desired degree of sizing of the papers to be finished. Furthermore, the size press liquor may comprise further substances, such as, for example, starch, pigments, optical brighteners, biocides, strength agents for paper, fixing agents, antifoams, retention aids and/or drainage aids. The application to the paper may be effected by means of a size press or other application units, such as a film press, speedsizer or gate-roll. The amounts of polymer which are applied to the surface of paper products are, for example, from 0.005 to 1.0 g/m², preferably from 0.01 to 0.5 g/m².

Unless otherwise evident from the context, the stated percentages in the examples are always percent by weight. The particle sizes were determined by means of a high performance particle sizer (HPPS) from Malvern using an He—Ne laser (633 nm) at a scattering angle of 173°.

The LT values were determined in 0.1% strength aqueous solution of the dispersion to be determined, using a DR/2010 apparatus from Hach at a wavelength of 600 nm.

### EXAMPLES

### Example 1

In a polymerization vessel which was equipped with a stirrer, reflux condenser, jacket heating and metering apparatus, 54.9 g of cationic potato starch (DS=0.07) were dispersed in 196.9 g of demineralized water under a nitrogen atmosphere and with stirring. Thereafter, 0.6 g of a 25% strength by weight aqueous calcium acetate solution and 6.0 g of a 1% strength by weight aqueous solution of a commercial α-amylase (Termamyl 120 L from Novo Nordisk) were added and the mixture was heated to 85° C. in the course of 45 min with stirring. After a further 30 minutes, the enzymatic starch degradation was stopped by adding 3.0 g of glacial acetic acid. After addition of 0.6 g of a 10% strength by weight aqueous iron(II) sulfate solution (FeSO₄.7H₂O), 2.7 g of an 18% strength by weight aqueous hydrogen peroxide solution was allowed to run in uniformly with stirring in the course of 30 min. The reaction temperature of 85° C. was further maintained. A stirred mixture consisting of 45.7 g of demineralized water, 0.1 g of a 40% strength by weight aqueous solution of a sodium alkanesulfonate (K30 from Bayer AG) and 73.5 g of styrene and 31.5 g of n-butyl acrylate was then metered at a constant metering rate in the course of 120 min. Simultaneously with the metering of the emulsion feed, the separate initiator feed was started: in the course of 150 min, 24.2 g of an 18% strength by weight aqueous hydrogen peroxide solution were metered at a constant metering rate into the reaction mixture. After the end of the initiator feed, the reaction mixture was stirred for a further 30 min at 85° C. before 3.3 g of a 10% strength by weight aqueous tert-butyl hydroperoxide solution were added. After a further 30 min at 85° C., the reaction mixture was cooled to 60° C., a further 4.3 g of 10% strength by weight aqueous tert-butyl hydroperoxide solution were then added and stirring was continued for a further 30 min. Thereafter, the reaction mixture was cooled to room temperature, 0.5 g of a 40% strength by weight aqueous solution of ethylenediaminetetraacetic acid in the form of the tetrasodium salt (Trilon B) was added and the pH of 6.0 was established with 8.2 g of a 25% strength by weight sodium hydroxide solution. After filtration (125 μm), a finely divided dispersion having a solids content of 33.5%, an LT value (0.01%) of 94 and a particle size of 76 nm (laser correlation spectroscopy) was obtained.

### Comparative Example 1 (Corresponding to Example 3 According to EP-B-1 056 783)

In a polymerization vessel equipped with a stirrer, reflux condenser, jacket heating and metering apparatus, 29.1 g of an oxidatively degraded potato starch (Perfectamyl® A 4692 from Avebe) were dispersed in 234.7 g of demineralized water with stirring. The mixture was heated to 85° C. with stirring, and 10.0 g of a 1% strength by weight aqueous solution of FeSO₄.7H₂O and 27.1 g of a 3% strength by weight aqueous hydrogen peroxide solution were added in succession. After stirring for 15 min at 85° C., the feeds of monomer and initiator were started simultaneously. Both a mixture consisting of 39.0 g of styrene, 16.0 g of n-butyl acrylate, 16.0 g of tert-butyl acrylate and 4.0 g of acrylic acid and, separately therefrom, 21.9 g of a 3% strength by weight aqueous hydrogen peroxide solution were each metered at constant metering rate in the course of 90 min. After the end of the metering, the reaction mixture was stirred for a further 15 min at 85° C., and 0.3 g of tert-butyl hydroperoxide (70%) was added for reactivation. After a further 60 min at 85° C., cooling to room temperature was effected and a pH of 6.5 was established with ammonia (25%). After filtration (100 μm), a finely divided dispersion having a solids content of 24.1%, an LT value (0.01%) of 88 and a particle size of 81 nm (laser correlation spectroscopy) was obtained.

### Comparative Example 2 (Corresponding to Example 5 of EP-B-1 056 783)

Comparative example 1 was repeated, but a mixture of 37.5 g of styrene and 37.5 g of n-butyl acrylate were metered as monomer feed. 0.5 g of tert-butyl acrylate was used in the reactivation. 3.3 g of NaOH (25%) were added for adjusting the dispersion to a pH of 6.5. After filtration (100 μm), a finely divided dispersion having a solids content of 24.0%, an LT value (0.01%) of 91 and a particle size of 69 nm (laser correlation spectroscopy) was obtained.

### Comparative Example 3 (Corresponding to Example 9 of EP-B-1 056 783)

In a polymerization vessel which was equipped with a stirrer, reflux condenser, jacket heating and metering apparatus, 24.5 g of an oxidatively degraded potato starch (Perfectamyl® A 4692 from Avebe) were dispersed in 238.5 g of demineralized water with stirring in a nitrogen atmosphere. The mixture was heated to 85° C. with stirring, and 5.2 g of a 1% strength by weight aqueous solution of FeSO₄.7H₂O and 16.0 g of a 3% strength by weight aqueous hydrogen peroxide solution were added and stirring was continued for a further 15 min at 85° C. The feeds of monomer and initiator were then started simultaneously. Both a mixture consisting of 32.7 g of styrene, 23.1 g of n-butyl acrylate and 19.2 g of methyl methacrylate and, separately therefrom, 21.9 g of 3% strength by weight aqueous hydrogen peroxide solution were each metered at a constant metering rate in the course of 90 min. After the end of the metering, stirring was effected for a further 15 min at 85° C. and 0.4 g of tert-butyl hydroperoxide (70%) was then added for reactivation. After a further 60 min at 85° C., cooling to room temperature was effected, 2.2 g of a 10% strength by weight aqueous solution of ethylenediaminetetraacetic acid in the form of the tetrasodium salt (Trilon B) were added and a pH of 6.5 was established with 2.5 g of sodium hydroxide solution (25%). After filtration (100 μm), a finely divided dispersion having a solids content of 23.4%, an LT value (0.01%) of 89 and a particle size of 64 nm (laser correlation spectroscopy) was obtained.

### Comparative Example 4 (Corresponding to Example 10 of EP-B-1 056 783)

In a polymerization vessel which was equipped with a stirrer, reflux condenser, jacket heating and metering apparatus, 25.7 g of an oxidatively degraded, cationized potato starch (Amylofax 15 from Avebe) were dispersed in 237.4 g of demineralized water with stirring in a nitrogen atmosphere. The mixture was heated to 85° C. with stirring, and 5.9 g of a 1% strength by weight aqueous solution of FeSO₄.7H₂O and 17.3 g of a 3% strength by weight aqueous hydrogen peroxide solution were added in succession and stirring was continued for a further 15 min at 85° C. The feeds of monomer and initiator were then started simultaneously. Both a mixture consisting of 43.3 g of styrene, 20.2 g of n-butyl acrylate and 11.5 g of methyl methacrylate and, separately therefrom, 21.9 g of 3% strength by weight aqueous hydrogen peroxide solution were each metered at a constant metering rate in the course of 90 min. After the end of the metering, stirring was continued for a further 15 min at 85° C., and 0.5 g of tert-butyl hydroperoxide (70%) was then added for reactivation. After a further 60 min at 85° C., cooling to room temperature was effected, 2.6 g of a 10% strength by weight aqueous solution of ethylenediaminetetraacetic acid in the form of the tetrasodium salt (Trilon B) were added and a pH of 6.5 was established with 3.1 g of sodium hydroxide solution (25%). After filtration (100 μm), a finely divided dispersion having a solids content of 24.7%, an LT value (0.01%) of 92 and a particle size of 67 nm (laser correlation spectroscopy) was obtained.

### Comparative Example 5 (Corresponding to Example 1 from WO-A-02/14393)

In a polymerization vessel which was equipped with a stirrer, reflux condenser, jacket heating and metering apparatus, 77.1 g of an oxidatively degraded potato starch (Amylex 15 from Südstärke) in 159.6 g of demineralized water were initially taken under a nitrogen atmosphere and with stirring. The mixture was heated to 85° C. in the course of 45 min with stirring, and 0.9 g of a 25% strength by weight aqueous calcium acetate solution and 5.4 g of a 1% strength by weight aqueous solution of a commercial α-amylase (Termamyl 120 L from Novo Nordisk) was added. After 30 minutes, the enzymatic starch degradation was stopped by adding 8.6 g of glacial acetic acid. 17.1 g of a 1% strength by weight aqueous iron(II) sulfate solution (FeSO₄.7H₂O) were then added to the reaction mixture. At a reaction temperature which was still 85° C., a monomer mixture consisting of 53.6 g of demineralized water, 2.7 g of a 4% strength by weight aqueous solution of a sodium alkanesulfonate (K30 from Bayer AG) and 105.0 g of styrene and 45.0 g of n-butyl acrylate were then allowed to run in at a constant metering rate in the course of 90 min. The initiator feed began simultaneously with the monomer feed. In the course of the first 30 min, 21.4 g of a 30% strength by weight hydrogen peroxide solution were added. 7.0 g of a 30% strength by weight hydrogen peroxide solution were then metered in 75 min. After the monomer feed was complete, the temperature was kept at the polymerization temperature up to the end of the initiator feed. Thereafter, cooling to room temperature was effected and a pH of 5.0 was established with NaOH (25%). After filtration (125 μm), a finely divided dispersion having a solids content of 36.1%, an LT value (0.01%) of 79 and a particle size of 181 nm (laser correlation spectroscopy) was obtained.

### Comparative Example 6 (Corresponding to “Cationic Dispersion 2” according to EP-A-0307816)

In a polymerization vessel which was equipped with a stirrer, reflux condenser, jacket heating and metering apparatus, 31.1 g of an oxidatively degraded potato starch (Amylofax 15 from Avebe) in 199.5 g of demineralized water were initially taken under a nitrogen atmosphere and with stirring. The starch was dissolved with stirring by heating to 85° C. At this temperature, 5.6 g of glacial acetic acid, 0.05 g of iron(II) sulfate (FeSO₄.7H₂O) and 1.2 g of a 30% strength by weight hydrogen peroxide solution were added in succession. After 20 minutes, a further 1.2 g of the 30% strength by weight hydrogen peroxide solution were added. A mixture consisting of 66 g of n-butyl acrylate, 58.5 g of styrene, 0.07 g of sodium laurylsulfate and 43.5 g of demineralized water was then metered in the course of 2 h. The initiator feed of 21 g of a 5.5% strength by weight of hydrogen peroxide solution began simultaneously and was likewise metered in over 2 h at constant metering rate. After the end of the feeds, polymerization was continued for a further hour at 85° C. After filtration (125 μm), a dispersion having a solids content of 33.9%, an LT value (0.01%) of 86 and a particle size of 110 nm (laser correlation spectroscopy) was obtained.

The starch-containing polymer dispersions described above were tested as sizes for paper by the following test methods:

The determination of the degree of sizing was effected by the Cobb60 method according to DIN EN 20 535. The ink flotation test (IFT) was carried out according to DIN 53 126 using a blue paper test ink. The toner adhesion was determined according to EN 12883 at a constant speed on an IGT tester.

Application of the starch-containing polymer dispersions in combination with starch to paper:

An oxidatively degraded, commercially available potato starch was brought into solution by heating to 95° C. for a defined time. The solids content of the starch solution was then adjusted to 8%. The polymer dispersion to be tested in each case was then added in the stated concentrations to the starch solution. The mixture of starch solution and polymer dispersion was then applied at a temperature of 50° C. by means of a size press to a paper having a basis weight of 80 g/m² which had been lightly presized in the pulp with AKD (C₁₈-alkyldiketene). The absorption of the preparation was in the range of 40-45%. Thereafter, the papers thus treated were dried by means of contact drying at 90° C., conditioned for 24 h at 50% relative humidity and then subjected to the abovementioned tests. The results are stated in the table below.

TABLE 1

| | | | | | Toner |
|---|---|---|---|---|---|
| | | | | | adhesion |
| | Cobb60 [g/m²] | | IFT [min] | | [% ink |
| | 2 g/l | 4 g/l | 2 g/l | 4 g/l | density] |
| Example 1: SC 33.5%, | 27 | 25 | 14 | 24 | 87 |
| PS 76 nm | | | | | |
| Comparative example 1: | 52 | 30 | 5 | 18 | 75 |
| SC 24.1%, PS 81 nm | | | | | |
| Comparative example 2: | 35 | 26 | 5 | 15 | 63 |
| SC 24%, PS 69 nm | | | | | |
| Comparative example 3: | 35 | 28 | 17 | 26 | 61 |
| SC 23.4%, PS 64 nm | | | | | |
| Comparative example 4: | 29 | 25 | 18 | 26 | 72 |
| SC 24.7%, PS 67 nm | | | | | |
| Comparative example 5: | 77 | 32 | 2 | 14 | 77 |
| SC 36.1%, SC 181 nm | | | | | |
| Comparative example 6: | 57 | 35 | 4 | 17 | 79 |
| SC 33.9%, SC 110 nm | | | | | |

SC = Solids content
PS = Particle size of the dispersed polymer particles

1. A finely divided, starch-containing polymer dispersion obtained by the free radical emulsion copolymerization of ethylenically unsaturated monomers in the presence of at least one redox initiator and starch, wherein the ethylenically unsaturated monomers comprise
(a) from 45 to 55% by weight of at least one optionally substituted styrene, methyl methacrylate, acrylonitrile and/or methacrylonitrile,
(b) from 15 to 29% by weight of at least one C₁-C₁₂-alkyl acrylate and/or one C₂-C₁₂-alkyl methacrylate and
(c) from 0 to 10% by weight of at least one other ethylenically unsaturated copolymerizable monomer
and the starch comprises
(d) from 15 to 35% by weight of a degraded cationized starch which has a molar mass M_{w} of from 1000 to 65 000
provided the sum of (a)+(b)+(c)+(d) is 100% and is based on the total solids content.

2. The finely divided, starch-containing polymer dispersion according to claim 1, wherein the ethylenically unsaturated monomers comprise
(a) from 47 to 51% by weight of at least one optionally substituted styrene, methyl methacrylate, acrylonitrile and/or methacrylonitrile,
(b) from 19 to 25% by weight of at least one C₁-C₁₂-alkyl acrylate and/or one C₂-C₁₂-alkyl methacrylate and
(c) from 0 to 10% by weight of at least one other ethylenically unsaturated copolymerizable monomer
and the starch comprises
(d) from 24 to 30% by weight of a degraded cationized starch which has a molar mass M_{w} of from 2500 to 35 000
provided the sum of (a)+(b)+(c)+(d) is 100% and is based on the total solids content.

3. The finely divided, starch-containing polymer dispersion according to claim 1, wherein the ethylenically unsaturated monomers comprise
(a) from 47 to 51% by weight of at least one monomer from the group consisting of styrene, methyl methacrylate, acrylonitrile and/or methacrylonitrile,
(b) from 19 to 25% by weight of at least one C₁-C₁₂-alkyl acrylate and/or one C₂-C₁₂-alkyl methacrylate and
(c) from 0 to 10% by weight of at least one monomer from the group consisting of stearyl acrylate, stearyl methacrylate, palmityl acrylate, behenyl acrylate, behenyl methacrylate, vinyl acetate, vinyl propionate, hydroxyethyl acrylate, hydroxyethyl methacrylate, N-vinylformamide, acrylamide, methacrylamide, N-vinylpyrrolidone, N-vinylcaprolactam, N-vinylimidazole, acrylic acid, methacrylic acid, acrylamidomethylpropanesulfonic acid, styrenesulfonic acid, vinylsulfonic acid and salts of the monomers comprising acid groups
and the starch comprises
(d) from 24 to 30% by weight of a degraded cationized starch which has a molar mass M_{w} of from 2500 to 35 000
provided the sum of (a)+(b)+(c)+(d) is 100% and is based on the total solids content.

4. The finely divided, starch-containing polymer dispersion according to any of claim 1, wherein the ethylenically unsaturated monomers comprise
(a) from 47 to 51% by weight of at least one monomer from the group consisting of styrene, methyl methacrylate, acrylonitrile and/or methacrylonitrile,
(b) from 19 to 25% by weight of n-butyl acrylate, sec-butyl acrylate, isobutyl acrylate, tert-butyl acrylate and/or 2-ethylhexyl acrylate and
(c) from 0 to 10% by weight of at least one monomer from the group consisting of stearyl acrylate, stearyl methacrylate, palmityl acrylate, behenyl acrylate, behenyl methacrylate, vinyl acetate, vinyl propionate, hydroxyethyl acrylate, hydroxyethyl methacrylate, N-vinylformamide, acrylamide, methacrylamide, N-vinylpyrrolidone, N-vinylcaprolactam, N-vinylimidazole, acrylic acid, methacrylic acid, acrylamidomethylpropanesulfonic acid, styrenesulfonic acid, vinylsulfonic acid and salts of the monomers comprising acid groups
are used as ethylenically unsaturated monomers and the starch comprises
(d) from 24 to 30% by weight of a degraded cationized starch which has a molar mass M_{w} of from 2500 to 35 000
provided the sum of (a)+(b)+(c)+(d) is 100% and is based on the total solids content.

5. A process for the preparation of the finely divided, starch-containing polymer dispersions according to claim 1, comprising polymerizing the following in an aqueous medium in the presence of a redox initiator
(a) from 45 to 55% by weight of at least one optionally substituted styrene, methyl methacrylate, acrylonitrile and/or methacrylonitrile,
(b) from 15 to 29% by weight of at least one C₁-C₁₂-alkyl acrylate and/or one C₂-C₁₂-alkyl methacrylate and
(c) from 0 to 10% by weight of at least one other ethylenically unsaturated copolymerizable monomer
and
(d) from 15 to 35% by weight of a degraded cationized starch which has a molar mass M_{w} of from 1000 to 25 000, provided the sum (a)+(b)+(c)+(d) is 100%.

6. The process according to claim 5, wherein the initiator is selected from the group consisting of hydrogen peroxide, peroxides, hydroperoxides and/or azo initiators and is added to the polymer dispersion after the end of the main polymerization so that a postpolymerization is carried out.

7. The process according to claim 6, wherein tert-butyl hydroperoxide is the initiator added to the polymer dispersion for the postpolymerization.

8. The process according to claim 5, wherein the cationized starch is enzymatically and/or oxidatively degraded before the beginning of the polymerization.

9. The process according to claim 5, wherein, after the end of the polymerization, a complexing agent for heavy metal ions is added to the polymer dispersion in an amount sufficient to bond all heavy metal ions with complex formation.

10. A method of using the starch-containing polymer dispersions according to claim 1 as sizes for paper, board and cardboard.
